(19) United States
(12) Patent Application Publication
(10) Pub. No.: US 2011/0125364 A1
(43) Pub. Date: May 26, 2011

(54) METHOD AND SYSTEM FOR DIAGNOSING A MALFUNCTION OF AN AUTOMOBILE

(75) Inventor: Damien Delcroix, Le Mesnil Le Roi (FR)

(73) Assignee: RENAULT S.A.S., Boulogne-Billancourt (FR)

(21) Appl. No.: 12/674,907

(22) PCT Filed: Aug. 19, 2008
(86) PCT No.: PCT/FR2008/051509

§ 371 Date: Jul. 12, 2010

(30) Foreign Application Priority Data
Aug. 27, 2007 (FR) 0757187

(51) Int. Cl. G06F 7/00

(52) U.S. Cl. 701/33; 701/29

(57) ABSTRACT

A method for diagnosing a malfunction in an automobile that uses a diagnosis tool and an analysis of data or control instructions provided by a calculation module assembly onboard the vehicle and converting the operation of a set of functional members of the vehicle by dynamically displaying the values of the data or the links to the controls within the display of the diagnosis method. The method includes: developing an enriched display structure of the vehicle operation control; developing a list of control data to be refreshed; recovering the refreshed control data from the respective calculation modules; and developing a final display from the enriched display structure and the refreshed control data; wherein the developing an enriched display structure, the list of data to be refreshed, and the recovering the refreshed data and of developing the final display are carried under control of a supervision module.

The invention relates to diagnosing a malfunction of a transport means such as an airplane or boat, more specifically an automobile, used in repair or maintenance workshops.

Currently, when a vehicle exhibits a failure, that is to say a malfunction or a failing, in order to identify its cause, a diagnostic method is applied, for example in the form of a fault-tracing tree, which makes it possible to identify a cause from a symptom, notably formulated by the owner or the driver of the vehicle.

This diagnostic method is conducted step by step and must culminate in the identification of the cause of the failing in order to determine the repair to be made to the vehicle.

Generally, at each step, or, generally, at least some of the steps of the diagnostic method, the technician has to check or control computation modules onboard the automobile, in order to recover diagnostic data or to activate functions internal to these modules.

In parallel with this diagnostic method, which makes it possible to trace a defective member by successive steps, the technician has a certain number of onboard resources in the vehicles. He thus has the possibility of recovering diagnostic data from computational modules of the vehicle or activating diagnostic functions internal to these modules.

These resources deliver directly accessible information. They relate to the operation of members of the vehicle for which they are responsible.

During the diagnosis, the technician generally uses a diagnostic tool that incorporates diagnostic software making it possible either to apply the diagnostic method, or to recover data or to activate diagnostic controls deriving from the computational modules.

This solution has a certain number of major drawbacks.

In practice, the diagnostic tool offers the technician a certain number of human/machine interfaces, in the form of screens that correspond either to the steps of a diagnostic method, or to a display of diagnostic data obtained from computation modules, or else to the activation of a diagnostic function internal to the computation module.

Thus, when running the diagnostic method, the technician may be required to check diagnostic values obtained from the computation modules against reference values or to activate an internal diagnostic function to compare its effects to so-called reference behaviors.

This consultation entails moving from one screen to another and requires a certain number of navigation procedures, which consequently leads to a considerable and pointless waste of time. Moreover, this solution generates a not-inconsiderable risk of errors, the transition from one screen to another being able to cause a consultation error, for example the acquisition of erroneous diagnostic data, and therefore a diagnostic error.

However, the acquisition of control data is a necessary phase, inasmuch as, depending on the result of the check, the diagnostic method may be continued to different subsequent steps, according to the value of the checked data.

In light of the above, there is a need to have a diagnostic tool that enables a user to use both a diagnostic method making it possible to trace and identify a failing or a failure, and data or controls originating from computation modules onboard the vehicle and do so within one and the same human/machine interface.

The subject of the invention is therefore, according to a first aspect, a method of diagnosing a malfunction of an automobile by using a diagnostic tool and by analyzing control data or instructions available from a set of computation modules onboard the automobile and reflecting the operation of a set of functional members of the vehicle.

According to a general characteristic of this method, the latter comprises the steps of:
generating an enriched display structure describing a sequence of control operations to be carried out on the vehicle enriched with control data or instructions;
generating a list of control data to be refreshed;
recovering refreshed control data originating from the respective computation modules;
generating a final display from the enriched display structure and from the refreshed control data.

Said steps of generating the enriched display structure, the list of data to be refreshed, of recovering the refreshed data and of generating the final display being carried out under the control of a supervision module.

According to another characteristic of this method, during the generation of the list of control data to be refreshed, diagnostic requests are generated from a base containing, for each computation module, a description of the diagnostic requests.

Moreover, during the recovery of the control data, one or more responses transmitted by the computation modules are, for example, decoded.

It is also possible to update a refreshed control data file based on the recovered control data.

According to yet another characteristic of the method, the final display can thus be generated from the display structure and from display parameters extracted from a display database that correspond to a human/machine interface on which the final display is to be viewed.

According to yet another characteristic of the inventive method, during the generation of the display structure and during the generation of the list of control data to be refreshed, a diagnostic file is analyzed that contains a set of diagnostic instruction codes for the diagnostic tool and a set of markers for applying diagnostic instruction codes, said markers are detected and said markers are analyzed so as to produce a discrimination between a first type of marker tending to apply an action on the part of an operator and a second type of marker tending to recover control data or to control onboard diagnostic functions.

When a marker of the first type is detected, textual data or images are inserted into the enriched display structure.

Moreover, when a marker of the second type is detected, a complementary analysis of the marker is carried out to produce a discrimination between markers of a third type tending to apply a diagnostic function by means of the computation modules, and markers of a fourth type tending to acquire control data values.

For example, in response to the detection of a marker of the third type, a control marker is inserted into the enriched display structure.

It is also possible, in response to the detection of a marker of the fourth type, to insert on the one hand an item into a file containing the data to be refreshed, and on the other hand software components for controlling the reading of control data in the enriched display structure.

Another subject of the invention, according to a second aspect, is a system for diagnosing a malfunction of an automobile, comprising:
a first stage of generating an enriched display structure for controlling the operation of the vehicle based on a diagnostic method and data obtained from a diagnostic tool, and of generating a list of control data to be refreshed;
a second stage of dynamically recovering control data originating from respective computation modules onboard the automobile; and
a third stage of generating a final display from the enriched display structure and from the refreshed control data.

The system further includes one or more supervision stages for controlling said first, second and third stages.

Other aims, characteristics and advantages of the invention will become apparent from reading the following description, given purely as a nonlimiting example, and given with reference to the appended drawings in which:

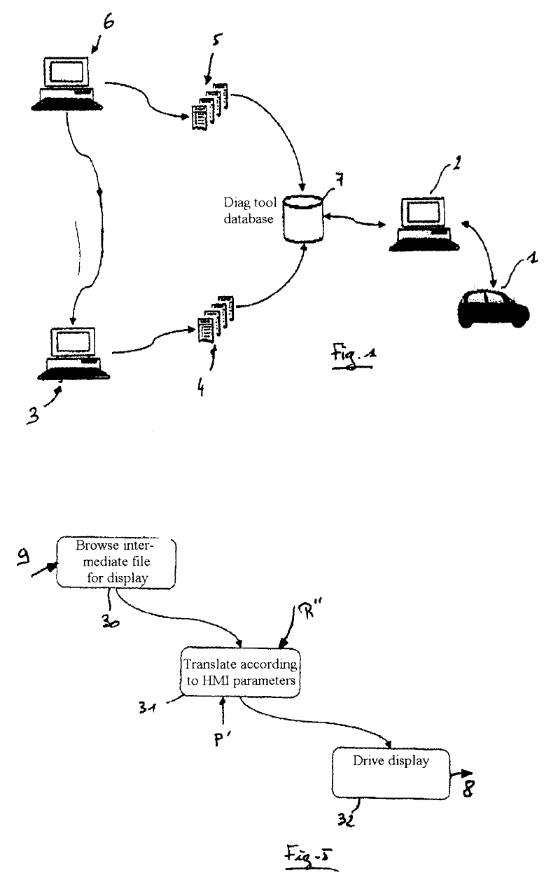

FIG. 1 is a block diagram illustrating the general architecture of a diagnostic installation for automobiles;

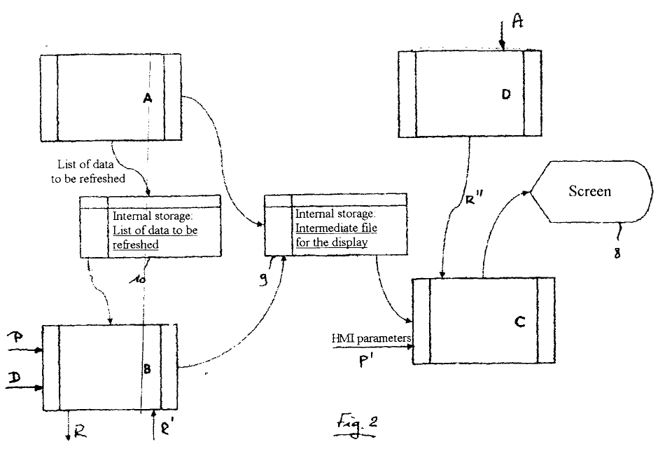

FIG. 2 illustrates the structure of a diagnostic system for automobiles according to the invention;

FIG. 3 is a flow diagram illustrating the main steps of the operation of the first stage of the system of FIG. 2;

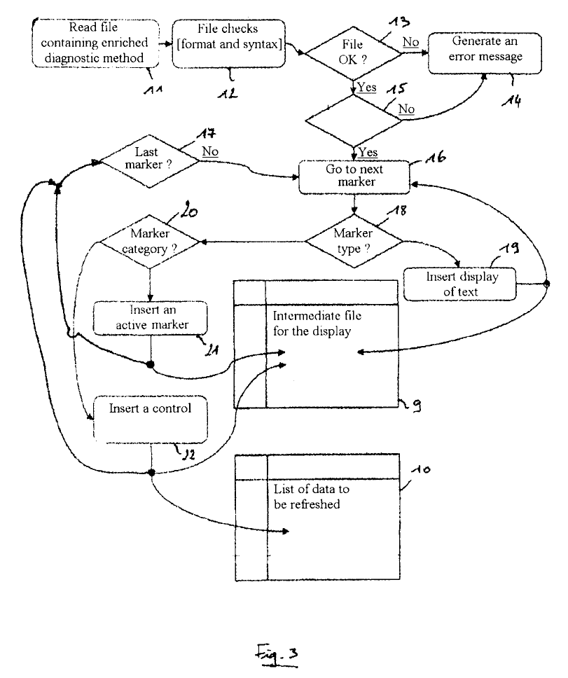

FIG. 4 is a flow diagram illustrating the main steps of operation of the second stage of the system of FIG. 2;

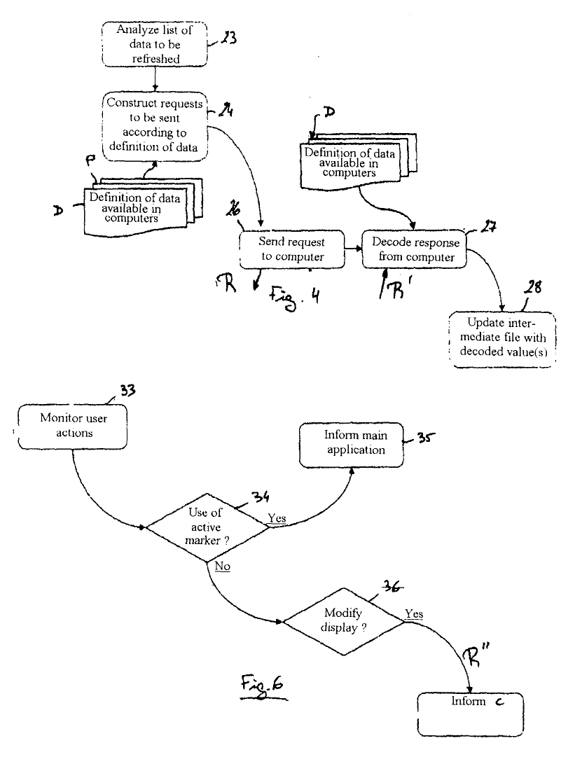

FIG. 5 is a flow diagram illustrating the main steps of the operation of the third stage of the system of FIG. 2; and

FIG. 6 is a flow diagram illustrating the main steps of the operation of the supervision stage of the system of FIG. 2.

The diagnostic installation illustrated in FIG. 1 is intended to check for a malfunction of an automobile 1.

As can be seen in this figure, the diagnosis is based on the use of a diagnostic tool 2 that makes it possible to present to a technician and use diagnostic methods in combination with control data or instructions delivered by computation modules onboard the vehicle 1.

Diagnosing a vehicle entails first constructing the set of data necessary to the conduct of the diagnosis in a repair or maintenance workshop.

Thus, the diagnostic methods are generated, for example, by using software deriving from or hosted, for example, on a microcomputer 3 in order to generate a certain number of files, such as 4, which define the diagnostic methods to be used and include references to onboard diagnostic resources, namely the computation modules.

Moreover, the definition of the diagnostic resources is recovered through the use of a set of files, such as 5, generated by means of software for producing diagnostic data deriving from or hosted, for example, within a microcomputer 6. These files 5 define the resources onboard the vehicle that are likely to deliver the control data or instructions and the communication parameters to be used to recover the control data from the computation modules.

As can be seen, provision is made for communication between the hardware and software resources 3 and 6, one used to produce the diagnostic methods and the other to produce diagnostic data. These two hardware resources can perfectly well coexist, for example, in one and the same microcomputer and be made accessible through a computer network.

Moreover, the content of the files 4 and 5 is made available to the diagnostic tool 2, for example, through the intermediary of a database 7 or else through any set of files made available locally in the diagnostic tool 2 or made available to this online tool through a computer network.

In other words, the diagnostic methods and the references to the computation modules used to recover the control data or else to activate their diagnostic functions are combined within the database 7 of the diagnostic tool 2 to directly incorporate references to these diagnostic resources in the diagnostic methods and thus, as will be described in detail hereinbelow, dynamically display on a human/machine interface a result simultaneously incorporating a diagnostic method and control data or instructions.

Referring now to FIG. 2, the diagnostic tool 2 includes a set of modules A, B, C and D that operate in combination to generate a final display on a human/machine interface, here formed by a screen 8, to present to a technician information containing, in combination, diagnostic methods, control data and control instructions.

The first stage A is used to generate an intermediate file containing an enriched display structure 9 combined with control or instruction data referring to diagnostic resources.

It also delivers to the second stage B a file in the form of a list 10 describing the control data to be refreshed.

The second stage B recovers this list of control data to be refreshed. It also recovers a set of parameters P for communication with the onboard computation modules and descriptors D used to define the diagnostic resources available in the computation modules, these data items P and D being recovered from the database 7.

From this information, the second stage B dialogs with the computation modules through requests R and responses R′ containing, among other things, the updated control data, which are decoded then stored in the intermediate file 9 in the form of dynamic data. For example, these requests are generated from a list of data requests extracted, for each computation module, from a base.

As can be seen in FIG. 2, the third stage C recovers the control data refreshed by reading the enriched display structure 9 and dynamically updated by stage B and thus generates the final display according to display parameters P′, extracted for example from a base incorporated in the database 7, which describe, for each human/machine interface likely to be used, the necessary display parameters.

The operation of the main items involved in constructing the diagnostic system, and in particular the third stage C for generating the final display, is controlled by a fourth stage D which generates and transmits to the third stage C requests R″ tending in particular to obtain a display modification, for example in response to actions A on the part of the user technician.

There now follows a description, with reference to FIG. 3, of the main steps in the operation of the first stage A of generation of the intermediate file.

During a first step 11, the stage A reads the file stored in the database 7 describing a diagnostic method enriched with diagnostic data and instructions, that is to say information used to recover the control data or to activate the diagnostic functions of the computation modules.

After checking the file, in particular with regard to its format and its syntax (step 12), a test is carried out (step 13) so as to check whether this file is correct.

If it is not, an error message is generated (step 14). In the next step 15, if it has been found that the file is correct, a check is run on the headers.

If the headers are incorrect, the process returns to the preceding step 14 so as to generate an error signal.

Otherwise, that is to say if the headers are correct, the first stage A proceeds to detect markers in the files, tending to execute diagnostic instructions.

As long as the marker detected is not the last marker (step 17), the detected marker is analyzed so as to determine its nature (step 18).

In particular, during this step 18, a discrimination is made between the coding markers used to provoke the application of an action on the part of the user technician and a second type of marker tending to recover control data or instructions.

If, during this step 18, it is detected that the marker is a marker of the first type, a content of textual or image type (step 19) describing the action to be carried out by the user technician, is inserted into the intermediate file 9.

On the other hand, if, during the preceding step 18, it is detected that the marker is a marker of the second type, that is to say a marker tending to recover control data or instructions, during the next step 20, the category to which this marker belongs is also detected.

In other words, a discrimination is made between markers of a third type, that tend to apply a diagnostic function and markers of a fourth type, tending to acquire control data values.

If it is a marker of the third type, there is then inserted, in the next step 21, a control marker into the file of the enriched display structure 9.

On the other hand, if it is a marker of the fourth type, during the next step 22, on the one hand the detail of the data to be refreshed is inserted into the file 10, and on the other hand a software component is inserted into the intermediate file 9 that makes it possible to graphically refresh the control data, for example a component of the “Active X®” type.

On completion of these steps, once the file no longer contains markers, the first stage has thus generated an enriched display structure that is intended for use by the third stage C to generate the final display and a list of data to be refreshed intended for use by the second stage B in order to be able to dynamically update the enriched display structure.

Referring to FIG. 4, the second stage B, during a first step 23, analyzes the file 10 and, in particular, the list of data to be refreshed. It then constructs the requests R to be sent to the computation modules from the data P describing the parameters to be used to communicate with the computation modules and the data D describing the data available in the computation modules (step 24).

During the next step 26, the duly generated requests are transmitted to the onboard computation module, one request at a time.

The responses R′ are then decoded (step 27) by using the data D describing the data available in the computers. The intermediate file is then updated with the updated control data (step 28).

It will be noted that the method applied within the second stage B is permanently carried out in order to dynamically refresh the data to be displayed and this is done with the best possible performance.

Referring now to FIG. 5, the third stage C is responsible for converting the intermediate file 9 into a final display intended for presentation to a user by means of the screen 8, according to the parameters P′ of the HMI used.

As indicated previously, this third stage C can be invoked by the fourth stage D (requests R″).

During a first step 30, the third stage C browses through the intermediate file.

From the parameters P′, this file is converted (step 31) so as to drive the screen 8 (step 32).

Finally, referring to FIG. 6, the fourth stage D monitors the actions of the users in order to indicate to the third stage C if it is necessary to regenerate the display. It will be noted that the actions of the users can be of various kinds, depending on the mode of operation of the diagnostic tool.

In other words, this supervision stage D is responsible for translating the commands entered manually by the user technicians into computer events intended for the diagnostic tool and, directly or not, for the third stage C.

In particular, according to the commands input by the users, the fourth stage D may cause a regeneration or a displacement of the display, activate a particular diagnostic function or even reinitialize the first stage A, for example in the case where there is a desire to use another diagnostic method.

Thus, during a first step 33, the fourth stage D scans the commands input by the users. When a marker is activated (step 34) reflecting a command tending to apply, for example, a particular diagnostic function, or even, in particular, to restart the first stage A, the main diagnostic application used within the diagnostic tool 2 is informed (step 35). If such is not the case, during the next step 36, a determination is made as to whether the user wanted a modification of the display. If such is the case, a corresponding request R″ is transmitted to the third stage C.

1-11. (canceled)

12. A method of diagnosing a malfunction of an automobile by using a diagnostic tool and by analyzing control data or instructions available from a set of computation modules onboard the vehicle and reflecting operation of a set of functional members of the vehicle, the method comprising:
generating an enriched display structure for controlling operation of the vehicle describing a sequence of control operations to be performed on the vehicle enriched with control data or instructions;
generating a list of control data to be refreshed;
dynamically recovering refreshed control data originating from the respective computation modules; and
generating a final display from the enriched display structure, the refreshed control data, and direct access to the control instructions,
the generating the enriched display structure, the generating the list of data to be refreshed, the dynamically recovering the refreshed data, and the generating the final display being carried out under control of a supervision module.

13. The method as claimed in claim 12, wherein, during the generation of the list of control data to be refreshed, diagnostic requests are generated from a base containing, for the computation modules, a list of data requests.

14. The method as claimed in claim 12, wherein, during the recovery of the control data, one or more responses transmitted by each computation module is/are decoded.

15. The method as claimed in claim 14, wherein a refreshed control data file is updated based on the recovered control data.

16. The method as claimed in claim 15, wherein the final display is generated from the enriched display structure, from the refreshed control data file, and from display parameters extracted from a display database that correspond to a human/machine interface on which the final display is to be viewed.

17. The method as claimed in claim 12, wherein, during the generating the enriched display structure and during the generating the list of control data to be refreshed, a diagnostic file is analyzed that contains a set of diagnostic instruction codes for the diagnostic tool and a set of markers for applying diagnostic instruction codes, the markers are detected and the markers are analyzed so as to produce a discrimination between a first type of markers tending to apply an action on the part of an operator and a second type of markers tending to recover control data or control instructions.

18. The method as claimed in claim 17, wherein, when a marker of the first type is detected, textual data or images are inserted into the enriched display structure.

19. The method as claimed in claim 18, wherein, when a marker of the second type is detected, the marker is discriminated between a marker of a third type tending to control a diagnostic function and a marker of a fourth type tending to acquire computation data values.

20. The method as claimed in claim 19, wherein, in response to the detection of a marker of the third type, a control marker is inserted into the enriched display structure making it possible to activate the control.

21. The method as claimed in claim 20, wherein, in response to the detection of a marker of the fourth type, there is inserted, into a file containing the data to be refreshed, a software component for controlling the reading of control data.

22. A system for diagnosing a malfunction of a vehicle, comprising:
a first stage that generates an enriched display structure for controlling the operation of the vehicle and generating a list of control data to be refreshed;
a second stage that recovers refreshed control data originating from computation modules onboard the vehicle;
a third stage that generates a final display from the enriched display structure and from the refreshed control data; and
one or more supervision stages that control the first, second, and third stages and actions of a user technician.
